(19) United States
(12) Patent Application Publication
(10) Pub. No.: US 2009/0043946 A1
(43) Pub. Date: Feb. 12, 2009

(54) ARCHITECTURE FOR VERY LARGE CAPACITY SOLID STATE MEMORY SYSTEMS

(76) Inventors: Randall K. Webb, Hillsboro, OR (US); Jawad B. Khan, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/836,244

(22) Filed: Aug. 9, 2007

(51) Int. Cl. G06F 12/02

(52) U.S. Cl. 711/102; 711/E12.002

(57) ABSTRACT

To provide a feasible means to connect many non-volatile memory modules into a very large capacity solid-state memory, a group modules may be connected in a serial manner to form a unidirectional loop with the memory controller. In some embodiments the same serial connection may be used to communicate commands, write data, and/or configuration data from the memory controller to each memory module, and to communicate read data and/or configuration status from each memory module to the memory controller. Some memory controllers may have capacity to handle multiple such loops.

### BACKGROUND

Non-volatile solid state memory modules are becoming more attractive for use in small-to-medium size mass storage systems due to dropping prices and increasing bit densities. However, individual non-volatile solid state memory modules typically have a high pin count to handle the parallel data and/or address lines. Combining enough of these modules to create a large mass storage system may create a high density of interconnections, with the attendant signal-integrity issues that require slowing down the data rate. In addition, connecting many of these devices on a shared bus may create high loading on the bus, and again the data rate must be slowed down enough to accommodate the degradation in signal quality.

### BRIEF DESCRIPTION OF THE DRAWINGS

Some embodiments of the invention may be understood by referring to the following description and accompanying drawings that are used to illustrate embodiments of the invention, In the drawings:

FIG. 1 shows a block diagram of a memory system, according to an embodiment of the invention.

FIG. 2 shows a block diagram of a non-volatile memory module, according to an embodiment of the invention.

FIG. 3 shows a format of a data sequence that may be transmitted and/or received by a memory module, according to an embodiment of the invention.

FIGS. 4A-4E show a flow diagram of operations performed by a memory module upon receiving a data sequence, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented in one or any combination of hardware, firmware, and software. The invention may also be implemented as instructions contained in or on a machine-readable medium, which may be read and executed by one or more processors to enable performance of the operations described herein. A machine-readable medium may include any mechanism for storing, transmitting, and/or receiving information in a form readable by a machine (e.g., a computer). For example, a machine-readable medium may include a tangible storage medium, such as but not limited to read only memory (ROM); random access memory (RAM); magnetic disk storage media; optical storage media; a flash memory device, etc. A machine-readable medium may also include a propagated signal which has been modulated to encode the instructions, such as but not limited to modulated electromagnetic, optical, or acoustical carrier wave signals.

Various embodiments of the invention may use serially-connected memory modules and token-based serial communication protocols to achieve very high capacity memory systems with low pin counts on the modules. Using serial connections for the data lines may reduce pin count over a parallel data line configuration. Using buffered in/out connections to daisy-chain the modules together may effectively eliminate bus loading concerns, even if many memory modules are connected together in this manner. Using a token-passing technique may control access to these daisy-chain connections and prevent the different memory modules from interfering with each other.

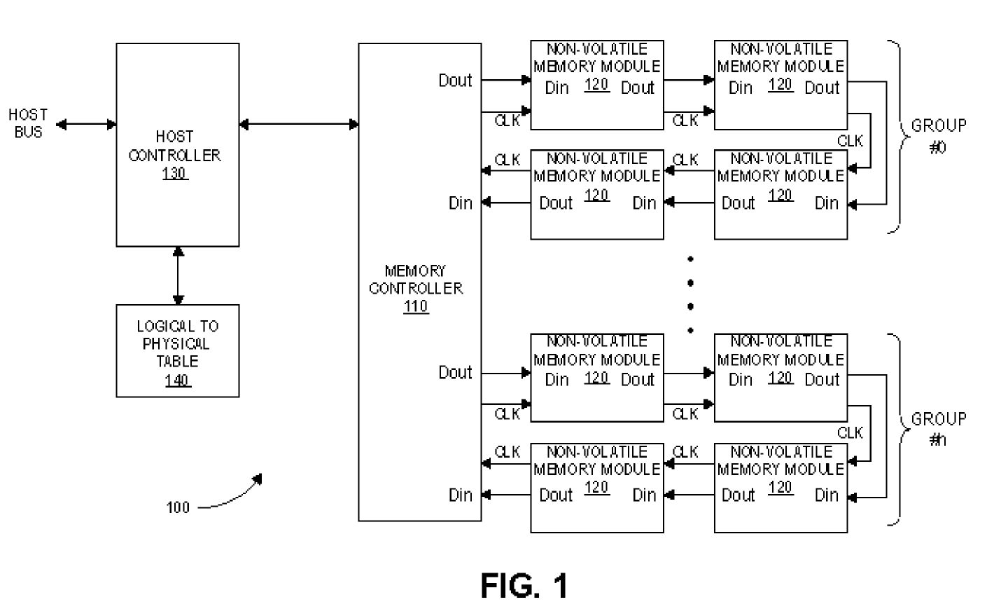

FIG. 1 shows a block diagram of a memory system, according to an embodiment of the invention. The illustrated system 100 may include a host controller 130, a non-volatile memory controller 1 10, and a quantity of non-volatile memory modules 120 that are configured into one or more groups of serially-connected memory modules 120. In some embodiments, the host controller 130 may provide an interface between the one or more memory controllers and a host computer. The host controller 130 may also perform various high-level tasks pertaining to memory operation, such as converting logical addresses to physical addresses (and vice-versa) using a logical-to-physical table 140.

Memory controller 110 may be configured to direct specific commands, addresses, write data, and/or configuration parameters to specific groups of memory modules (e.g., group #0), and receive read data and/or configuration status from those groups of memory modules. The memory controller may be configured in various ways, such as but not limited to hardwired circuitry, one or more state machines, programmable logic, an instruction-executing processor, any combination of these, etc. Formatting of the commands, addresses, and write data may be performed in either the host controller or memory controller, depending on how these tasks are apportioned in the specific system. Host controller 130 and memory controller 110 are shown as separate logic units, but their functions may be combined into a single unit in some embodiments.

Memory modules 120 may have serial inputs and outputs for communication with the memory controller 1 10. To avoid the loading issues that arise when many modules are connected onto a common bus, multiple ones of these modules may be serially connected one to the other with unidirectional data connections, as shown in FIG. 1. The illustrated embodiment shows four such modules serially connected into one group (#0), and four more such modules serially connected into another group (#n). Other groups of four may also be included, depending on the number of such groups that the memory controller 110 is designed to handle. In one embodiment each physical output Dout directly drives only a single physical input Din, so adding more memory modules to the group will not degrade the signal waveform by overloading the output Dout.

The illustrated embodiment shows each Dout driving a single Din. This connection and/or the CLK signal described below may use any feasible type of signal technique, such as but not limited to a binary voltage, differential pair, etc. In some embodiments fiber optic signal interfaces may be used. The illustrated embodiment also shows a clock signal CLK being passed from module to module in much the same manner as the data signals. The CLK signal may be used as a timing signal to latch the data bits. In other embodiments, bit timing may be achieved in other ways, and a CLK signal may not be needed. Although the illustrated embodiment shows four modules serially connected in each group, any feasible number of one or more modules may be connected in this manner in each group.

In some embodiments, each module may fully buffer the data sequence it receives before transmitting anything itself. In such a configuration, multiple ones of the memory modules in the same group may be transmitting data at the same time. In other embodiments, a data sequence may be passed on to the next module as it is being received by the current module. In such a configuration, when one module is communicating data, some or all of the other modules in that group may be prevented from transmitting until that one module is finished. This bottleneck may limit the number of modules that can be connected in a group and still maintain sufficient overall bandwidth. Accordingly, multiple independent groups may be connected to the memory controller 110. Each of the groups may be simultaneously performing a data transfer to/from at least one of its modules. The tradeoff between the number of groups and the number of modules per group may depend on various factors, such as but not limited to: 1) maximum response time requirements for a data request (more modules in the group means potentially more wait time before beginning a transfer from a particular module), 2) the length of a data transfer from a module (shorter length means less wait time for another module in the group to begin a transfer), 3) the cost of providing additional ports in the memory controller, 4) etc. In some embodiments, the number of modules may be different in different groups, with the shorter groups able to provide faster average response times. Further, related data may be spread among multiple groups, so that different parts of the data may be read concurrently from the different groups, thereby shortening the time for the memory controller to retrieve the entire dataset.

For isolating a data request to a specific module within a particular group, each memory module 120 in the same group may be separately addressable or selectable in some manner. This may be done by assigning an identification value to each module in a setup sequence when the memory system is being initialized. In some embodiments, the upper bits of a complete memory address may form the identification for each module, with the lower bits specifying a particular byte/ word/ double word/ page, etc., within the module. In other embodiments, each module may be assigned an identifier that is not directly related to memory addresses.

In one embodiment, a setup sequence may comprise sending a base address from the memory controller to the first memory module in a group. The first memory module in the group may take the base address for itself, increment that address by a predetermined amount, and pass the incremented address to the next memory module, which would take that incremented address for itself and increment the address again before passing it on. Each memory module in the group may do the same. When the final memory module in the group passes an incremented address to the memory controller, each memory module in the group will have an address that is unique within that group, and the memory controller may be able to determine how many modules are in the group by comparing the received address with the original address.

In an alternate address setup scheme, the memory controller may pass a sequence of addresses to the first memory module, which may take the first address for itself, and strip that address from the sequence before passing the sequence on to the next memory module. Each module could do the same in turn, taking the first address it sees for itself and passing on the remaining addresses. As before, when the sequence is returned to the memory controller, the memory controller may determine how many modules are in the group by determining how many addresses have been stripped from the sequence. This technique permits out-of-order addresses to be assigned, but may take more processing in the memory modules than the technique described in the previous paragraph. Other embodiments may use other techniques to assign an address to each memory module.

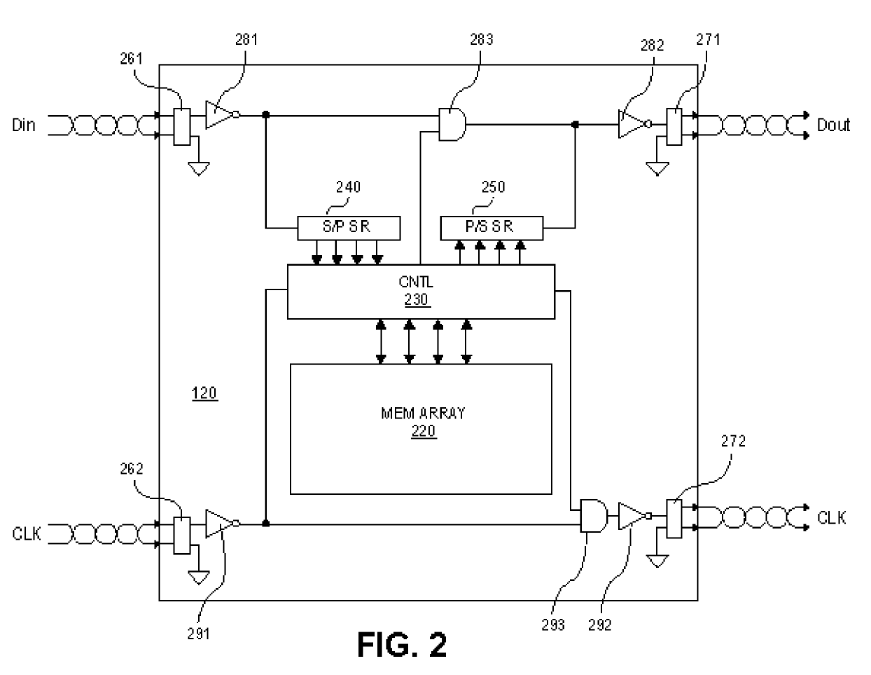

FIG. 2 shows a block diagram of a non-volatile memory module, according to an embodiment of the invention. This may be any feasible type of non-volatile memory module, such as but not limited to 1) NAND flash memory, 2) NOR flash memory, 3) ferro-magnetic memory, 4) phase-change memory, 5) optical memory, 6) etc. In the illustrated embodiment, non-volatile memory module 120 may comprise a memory array 220, control logic 230, serial-to-parallel shift register 240, parallel-to-serial shift register 250, differential-to-binary signal converters 261-262, binary-to-differential signal converters 271-272, and various logic gates 281, 282, 283, 291, 292, and 293. Note: although this example shows differential signaling between memory modules, other embodiments may use other techniques for communicating signals between modules.

In the illustrated example, differential data signals coming in to the memory module may be converted to binary logic signals at 261. In some embodiments an inter-module clock signal may also be used to latch the data signals, and is shown being converted to binary logic by another differential-to-binary logic converter 262. Once converted to binary and/or latched with the clock signal, the serial data bits may be moved into a serial-to-parallel shift register 240, where groups of data bits can be analyzed by control logic 230. This control logic may serve multiple purposes, such as but not limited to: 1) synchronize the incoming data on multi-bit boundaries (such as bytes), 2) separate the data into data types, such as preamble, addresses, control commands, and data to be stored in the memory array, 3) determine if this module is the intended recipient of this data transfer, 4) select the proper address in the memory array, 5) deliver write data to the memory array for storage, 6) receive read data from the memory array, 7) pass the read data to the next memory module, 8) pass part or all of the entire received data string from Din to Dout, 9) etc.

In some embodiments, data to be passed to the next memory module through Dout may come from several sources. The data may be passed from Din directly to Dout through logic gates 281, 283, and 282, and the clock signal CLK may be passed through as well, using appropriate logic such as 291, 293, 292 to keep it synchronized with the data signal. Alternatively, the data from Din may be placed in a buffer in control logic 230, to be later transmitted through Dout. In still another technique, data from memory array 220 may be passed to the next memory module by reading the data from the memory array by control logic 230, placing the data in parallel-to-serial shift register 250, and then shifting the data out through logic gate 282 and through binary-to-differential signal converter 271. In some embodiments, control logic 230 may buffer a certain amount of data internally between the shift registers and the memory array. Whenever appropriate (such as when incoming data is addressed to this particular memory module), logic gate 283 may be used to prevent the data at Din from being passed directly to Dout so subsequent memory modules will not have to deal with it. Alternatively, all data may be passed from Din to Dout, and all memory modules may ignore the data except for the one module to which the data is addressed.

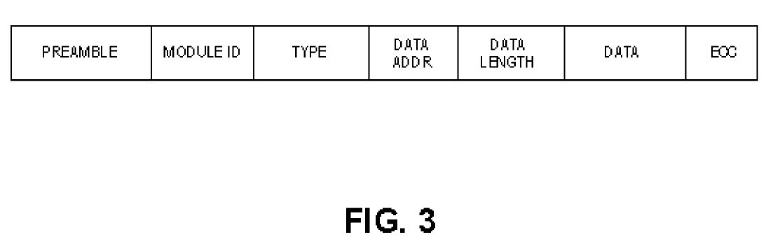

FIG. 3 shows a format of a data sequence that may be transmitted and/or received by a memory module, according to an embodiment of the invention. The illustrated format is an example, and other formats may be used as appropriate. In the illustrated format, a Preamble may be used at the beginning of the data sequence to allow a receiving module to synchronize on the byte boundaries of the following bit stream. A preamble may be a pre-determined bit pattern of sufficient length to reliably distinguish it from other, more random bit patterns that might be encountered at the beginning of a transmission. If such synchronization is not needed, the Preamble field may be omitted.

A Module ID field may indicate the identification of the module that this data sequence is intended for. If no specific module ID is being specified, a global ID may be used (e.g., all 0's, or all 1's). A global ID is an ID that is applicable to every memory module in the group. In some embodiments, a memory module that sees its own ID in this field will immediately shut off its output Dout so that the remainder of the data sequence will not be passed on to the next memory module, thus preventing unnecessary thrash by the down-stream memory modules. In other embodiments, the module receiving the data sequence will not pass it through immediately regardless of the module ID, but will buffer all or part of the entire data sequence before deciding if/when/how to pass it on to the next module. In some embodiments, a module performing a read operation will place its own ID in this field before transmitting the read data, so the memory controller that eventually receives the data can tell which module provided that data.

The Type field may indicate the purpose of this data sequence. Examples may include, but are not limited to: 1) a write command (write the contents of the following Data field into a memory array, or into a parameter storage area), 2) a read command (read data from the specified address range or from the parameter storage area and forward it to the memory controller), 3) an erase command, 4) an ID setup command (to assign IDs to the memory modules), 5) an information token (when requested data is to be returned from a memory module, an information ‘token’ is passed through the chain—only the device holding the information token is authorized to transmit its read data into the chain), 6) a combination of read command and information token (e.g., when the requested data is needed immediately), 7) etc. In some embodiments, all data sequences may have the same format to permit simple decoding by the memory modules.

The Data Address field may indicate the starting address within the memory array of the indicated memory module that data is to be read from or written to. In some embodiments, specific addresses may be reserved for parameter storage (i.e., the parameters that define how the memory module operates, such as but not limited to page size, ECC type, protocol conventions to be followed, etc.), but in other embodiments the Type field will indicate whether the data is to/from the memory array or the parameter storage area. The Data Length command may indicate the amount of data that is to be read from or written to the memory module, and in some embodiments may define the length of the remaining data sequence. If fixed-length data transfers are always used, and/or if different types of data formats indicated in the Type field have predetermined lengths, this field may be omitted. The Data field may contain the actual data that is being communicated.

To ensure that the entire data sequence has been received correctly, an Error Correcting Code (ECC) or other type of data integrity indicator may be included at the end of the transmission. The receiving device may recalculate the ECC and compare it to the received ECC to verify the integrity of the received data string.

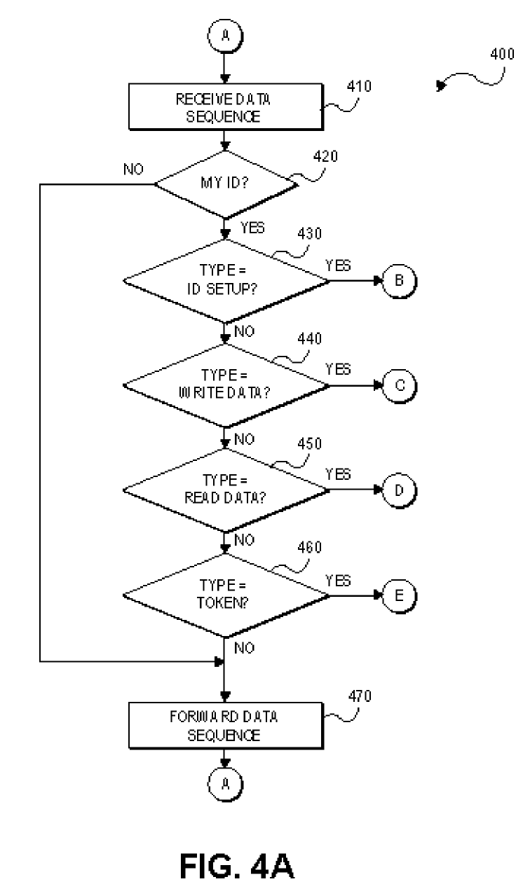

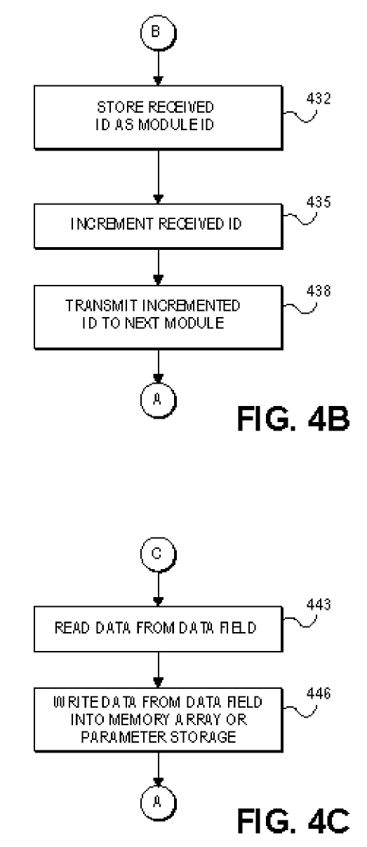

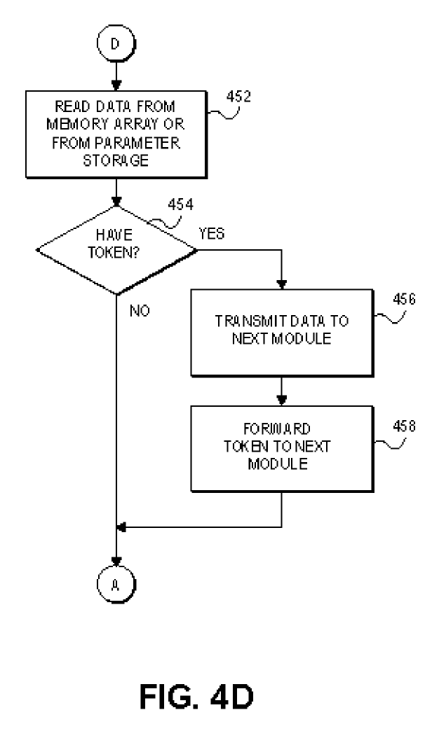

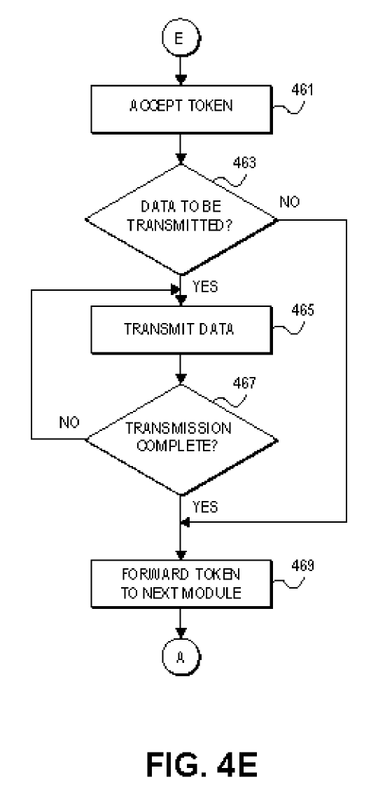

FIGS. 4A-4E show a flow diagram of operations performed by a memory module upon receiving a data sequence, according to an embodiment of the invention. When one of the memory modules 120 (see FIG. 1) receives a data sequence (e.g., the sequence described in FIG. 3) from the memory controller directly, or from an upstream memory module, it may follow the operations described here. In flow diagram 400, at 410 the data sequence may be received and at least partially examined. At 420 the ID field may be examined. If the ID indicates that the data sequence is not intended for this module, then the data sequence may be forwarded to the next module in the chain at 470, and processing may return to 410 to await another data sequence. However, if the ID indicates the data sequence is intended for this module, either because it is specifically addressed to this module or because it is a global ID, then the Type field may be examined at 430, 440, 450, and/or 460 to determine how to handle the data sequence. A global ID may be used, for example, when an ID Setup data sequence is being passed through the group, and/or when the memory controller wants to get a status check on all memory modules in the group.

If the Type field indicates at 430 that this data sequence is for ID Setup, then processing may go to 432 in FIG. 4B. If the Type field indicates at 440 that this data sequence is for writing data into this memory module, then processing may go to 443 in FIG. 4C. If the Type field indicates at 450 that this data sequence is for reading data from this memory module, then processing may go to 452 in FIG. 4D. If the Type field indicates at 460 that this data sequence is a token passing sequence, then processing may go to 461 in FIG. 4E. If the Type field indicates a type that the memory module does not recognize, it may simply forward the data sequence to the next module at 470, and/or may generate an error message for transmitting to the memory controller when the next token is received.

Returning to the type identification, if the Type field indicates at 430 that this data sequence is for setting up IDs in the memory modules, the memory module may take the ID value received in the Data field and store that ID as its own ID at 432 in FIG. 4B. In some embodiments, that ID in the data sequence may then be incremented by a specific amount at 435, and the data sequence (with the new, incremented ID value) may be forwarded to the next memory module at 438. The next memory module may then follow the same procedure and adopt the newly-incremented ID as its own ID before incrementing the ID and forwarding it to the next module.

In some embodiments the ID is separate from the memory address, and may be incremented by the same predetermined amount (e.g., by one) in each memory module. In other embodiments the ID may be formed of the upper bits of a physical memory address format. If the memory modules are all the same size, the ID may again be incremented by the same amount in each memory module. In both cases, when the memory controller receives the final incremented ID from the last memory module in the group, it can determine how many memory modules are in the group by comparing the final ID with the ID that it originally sent to the first memory module. In other embodiments, if the memory modules in the same group are allowed to have different capacities, each memory module may increment the ID by an amount that reflects its own memory size (e.g., increment by 1 for each 64 MB of addressable memory space in the module). When the memory controller receives the final incremented ID from the last memory module in the group, it can determine how much addressable memory space is contained in all the modules in the group, although it may not be able to determine how many physical modules make up that group.

Returning to 440 in FIG. 4A, if the Type field indicates that this data sequence contains data to be written into this memory module, then the data in the Data field may be read from the data sequence at 443 of FIG. 4C and written into the memory module at 446. If the data is intended as write data, it may be stored in the module's memory array, starting with the address indicated in the Data Address field. If the data represents operating parameters for the memory module, then the data may be written into appropriate registers in control logic 230 of FIG. 2. In some embodiments, different values in the Type field may be used to indicate whether this data is to be stored in the memory array or stored as operating parameters in the control logic.

Returning to 450 in FIG. 4A, if the Type field indicates that data is to be read from this memory module, then the data may be read at 452. In some embodiments, different values in the Type field may be used to indicate whether this data is to be read from the memory array 220 (e.g., a read data request), or from the parameter storage in control logic 230 (e.g., a status request). Regardless of the type of data being read, the data may not be transmitted to the next module until this module has possession of the information token, as determined at 454. In some embodiments, the module will wait until it receives the information token before transmitting the data at 456. In other embodiments, the data sequence that requested the read data will contain the information token, so the data may be transmitted immediately at 456. Once the data has been transmitted, the information token itself may be forwarded to the next memory module at 458, either as part of this transmission or in a subsequent transmission.

Returning to 460 in FIG. 4A, if the Type field indicates that this is a token-passing data sequence, then the information token may be accepted at 461 of FIG. 4E. If this module has no data to transmit as determined at 463, the information token may be forwarded to the next memory module at 469. If this module does have data to transmit, as determined at 463, then the data maybe transmitted at 465. When the transmission is complete, as determined at 467, then the information token may be forwarded to the next memory module at 469, either as a part of this transmission or in a subsequent transmission.

The foregoing description is intended to be illustrative and not limiting. Variations will occur to those of skill in the art. Those variations are intended to be included in the various embodiment so the invention, which are limited only by the spirit and scope of the following claims.

What is claimed is:

1. An apparatus, comprising
a non-volatile memory module comprising:
a non-volatile memory array;
a serial data input and a serial data output;
control logic coupled to the array, the serial data input, and the serial data output, the control logic to receive a data sequence through the serial data input, examine an identification field in the data sequence, transmit the data sequence from the serial data output if an identification of the non-volatile memory module does not match a value in the identification field, and perform an operation indicated in the data sequence if the identification of the non-volatile memory module matches the value in the identification field.

2. The apparatus of claim 1, wherein said matching the value in the identification field comprises matching a value specifically assigned to the non-volatile memory module.

3. The apparatus of claim 2, wherein said performing the operation comprises performing a write data operation to the non-volatile memory array.

4. The apparatus of claim 2, wherein said performing the operation comprises performing a read data operation from the non-volatile memory array.

5. The apparatus of claim 1, wherein said matching the value in the identification field comprises matching a global identification value.

6. The apparatus of claim 1, wherein said performing the operation comprises performing a parameter storage operation.

7. The apparatus of claim 1, wherein said performing the operation comprises performing a read parameter operation.

8. The apparatus of claim 1, wherein said performing the operation comprises performing an erase operation.

9. The apparatus of claim 1, wherein the control logic is further to receive an information token through the serial data input before transmitting data read from the non-volatile memory array.

10. A system, comprising:
a memory controller; and
a plurality of non-volatile memory modules, each non-volatile memory module having a serial data input and a serial data output;
wherein a first of the non-volatile memory modules has a serial data input coupled to a serial data output of the memory controller;
wherein a second of the non-volatile memory modules has a serial data output coupled to a serial data input of the memory controller;
wherein a remainder of the non-volatile memory modules are coupled serially between the first and second non-volatile memory modules.

11. The system of claim 10, wherein the memory controller is configured to assign identification values to each of the non-volatile memory modules by transmitting at least one identification value to the first memory module.

12. The system of claim 10, wherein the memory controller is configured to determine how many non-volatile memory modules are in the plurality of non-volatile memory modules by comparing a beginning identification value transmitted to the first non-volatile memory module with a final identification value received from the second non-volatile memory module.

13. The system of claim 10, wherein the memory controller is configured to retrieve read data from a particular one of the non-volatile memory modules by transmitting a read data command to the first non-volatile memory module and receiving the read data from the second non-volatile memory module.

14. The system of claim 10, wherein the memory controller is configured to transmit an information token to the first non-volatile memory module, the information token to be transmitted from memory module to memory module, with each particular memory module being authorized to transmit read data only after the particular memory module has received the information token and before the particular memory module has transmitted the information token.
